(19) United States
(12) Patent Application Publication
(10) Pub. No.: US 2012/0000074 A1
(43) Pub. Date: Jan. 5, 2012

(54) Erodible Label For Razor Cartridge

(76) Inventor: Marta PazosSchroeder, Waltham, MA (US)

(21) Appl. No.: 12/828,401

(22) Filed: Jul. 1, 2010

(51) Int. Cl. B26B 21/40; B23P 17/04

(52) U.S. Cl. 30/34.05; 29/428

(57) ABSTRACT

A novel razor cartridge is disclosed including at least one erodible label disposed onto at least one exterior surface of at least one razor cartridge component via label transfer technologies (e.g., heat transfer process). The erodible label is comprised substantially of a water soluble polymer (from about 10% to about 100% water soluble polymer by weight of composition), may wear off completely after about 2 to 10 shaves, and may include a plurality of erodible labels each with a different composition. An adhesive layer may be disposed above or below the erodible label. Further, the label may provide functional and/or aesthetic benefits, serve as cues or indicia communicated or obtained to the user before, during or after use of the razor product. In one embodiment, a water droplet label on the lube ring provides moisturization benefits during use and also conveys these benefits to the consumer before use (e.g., lubriciousness).

### FIELD OF THE INVENTION

This invention relates to razors, and particularly to improvements in razor cartridge components and manufacturing processes thereof.

### BACKGROUND OF THE INVENTION

With more and more features being included in razor systems and razor cartridges, it may be desirable to provide processes for producing enhanced razor cartridge components which would improve shaving attributes, decorate, or provide information about razor components to the user.

One such razor cartridge component, whether for male or female razor cartridges, is the lubricating body which generally provides added lubrication and comfort while shaving. Most lubricating bodies found on razor cartridges include a blend of polyethylene oxide and polystyrene. In male cartridges, the lubricating body is typically a lubricating strip (e.g., oftentimes referred to as a lube strip or lubrastrip) generally formed using an extrusion process. In female cartridges, such as those found in the Gillette® Venus® Embrace™ razor, the lubricating body may include a lubrication ring (e.g., lube ring) or as found in the Gillette® Venus® Embrace™ product, the lubricating body may include gel bars or soap wings. In either product, the lubricating body is generally formed using a molding process.

Prior pending patent application, Ser. No. 12/629,249, entitled “Razor Cartridge Components With Indicia,” filed Dec. 2, 2009, and assigned to the Assignee hereof, describes the formation of indicia on razor cartridge components where indicia for instance, may be recessed via injection molding a design into a lube ring. In order to change from one indicia design to another as may be desired with a launch of a new product and/or for marketing reasons, a previous mold of the injection molding process may likely not be useful, and as such, new indicia designs may generally require a new mold or a change in the molds which may typically be very costly and time-consuming. In addition, while this prior art patent application describes indicia formed using alternative methods (e.g., printing with ink) which are capable of providing an aesthetic benefit, indicia formed in this fashion were by and large not described as improving shaving attributes (e.g., comfort, closeness, safety) or other benefit (e.g., increased lubrication).

Thus, there is a need to provide a unique razor and method of manufacturing razor components suitable for both male and female razors enabling improved shaving attributes (e.g., comfort, closeness, safety) while also affording a consumer to be beneficially pleased and informed when choosing and using the razor products.

### SUMMARY OF THE INVENTION

In accordance with the present invention, a novel razor cartridge includes at least one erodible label disposed onto at least one exterior surface of at least one razor cartridge component using label transfer technology such as heat transfer processes, screen printing, roll coating, flexographic, or rotogravure, or any combination thereof, where the composition of the label is made of from about 10% to about 100% by weight of composition of one or more water-soluble polymers. The at least one erodible label provides at least one functional benefit, at least one an aesthetic benefit, at least one cue, at least one indicia, or any combination thereof.

The erodible label may be made of polyethylene oxide (PEO), polyvinyl alcohol, polyvinyl pyrrolidone, polyurethane, polyacrylate, polyureas, polyalkylene glycols, cellulose based polymers, or any combination thereof. Additionally, the erodible label may include scents, thermo-chromic pigments, lipids, waxes, moisturizing agents, exfoliating agents, inorganic salts, holographic inks, marbleized inks, hair growth retardants or inhibitors, or any combination thereof.

The erodible label desirably wears away completely from the exterior surface of the at least one razor cartridge component after about 2 to about 10 wet shaves, where a shave is about 200 strokes to about 250 strokes.

In another aspect of the present invention, the thickness of said erodible label is reduced by about 10% to about 75% after each shave.

Thus, generally the erodible label of the present invention is not permanent after a curing step in the label transfer technology.

The erodible label may include a plurality of erodible labels or layers, each of which may have a different composition.

The razor cartridge component includes a portion of at least one of the following: a lubricating body, a cap, a housing, a frame, a clip, a guard, a razor blade, a cartridge connecting structure, or any combination thereof.

The present invention is also directed to a razor cartridge including at least one erodible label disposed in a razor cartridge in place of a lubricating body (e.g., lube ring or lube strip) wherein the erodible label is applied via a label transfer technology.

The present invention is also directed to a method of making a razor cartridge including applying at least one erodible label onto at least one exterior surface of at least one component of the razor cartridge via at least one type of label transfer process wherein the at least one razor cartridge component includes a portion of at least one of the following: a lubricating body, a guard, a cap, a housing, a frame, a clip, a razor blade, a cartridge connecting structure, or any combination thereof.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a flow diagram depicting the formation of an erodible label on an exterior surface of a substrate in accordance with the present invention.

FIG. 1A is a side view of an erodible label disposed onto an exterior surface of a substrate formed using the process described in FIG. 1.

FIG. 1B is a top view of FIG. 1A.

FIG. 1C is a top view of an alternate embodiment of FIG. 1A.

FIG. 2 is a top view of a razor cartridge with an erodible label disposed onto an exterior surface of a lubricating body (e.g., lube ring) in accordance with the present invention.

FIG. 2A is a top view razor cartridge with an erodible label disposed onto an exterior surface of a frame in accordance with an alternate embodiment of the present invention.

FIG. 2B is a razor cartridge with erodible labels disposed on exterior surfaces of clips and the lube ring in accordance with an alternate embodiment of the present invention.

FIG. 2C is a razor cartridge with erodible labels disposed on an exterior surface of a foam in accordance with an alternate embodiment of the present invention.

FIG. 2D is a razor cartridge with erodible labels disposed on exterior surfaces of a gel bar, a lube strip and a guard in accordance with an alternate embodiment of the present invention.

FIG. 2E is a diagram showing a consumer detecting the erodible label of a razor product in a package from a store shelf in accordance with the present invention.

FIG. 2F is a top view of the razor cartridge of FIG. 2 attached to a razor handle.

FIG. 2G is a side view of a razor cartridge showing an erodible label disposed onto an exterior surface of a frame or housing in accordance with an alternate embodiment of the present invention.

FIG. 3 depicts a flow diagram showing the erodible label wearing away after subsequent shaves in accordance with the present invention.

FIG. 4 is a flow diagram showing an erodible label disposed onto an exterior surface of a substrate with an adhesive layer therebetween and the wearing away of both after subsequent shaves in accordance with the present invention.

FIG. 5 is a flow diagram showing erodible labels disposed onto an exterior surface of a substrate with an adhesive layer therebetween and the wearing away of both after subsequent shaves in accordance with the present invention.

FIG. 6 is a flow diagram showing an erodible label disposed onto an exterior surface of a substrate sandwiched between two adhesive layers and the wearing away of both after subsequent shaves in accordance with the present invention.

### DETAILED DESCRIPTION OF THE INVENTION

In a major aspect, the invention relates to a novel razor product having a razor cartridge which includes at least one erodible label disposed on an exterior surface of a substrate which may desirably be a razor cartridge component, such as but not limited to, a lubricating body or a frame. The label is formed in a novel modification of label transfer technologies such as heat transfer processes, silk screen processes, rolling coating processes, flexographic or rotogravure, or any other labeling processes comprising ink-base or combinations thereof, where the ink for these processes is comprised substantially of water-soluble polymers.

In the present invention, certain germane terms are defined as follows:

### Razor Cartridge Components

Razor cartridge components include the lubricating body, the guard, the cap, the housing, the frame, the clip, the razor blade, the cartridge connecting structure, or any combination thereof as contemplated in the present invention. The guard is typically disposed in the area in front of the blades, oftentimes including one or more flexible elastomeric elements, while the cap area is generally the area behind the blades, oftentimes made of a smooth elastomeric material and/or inclusive of a lubrastrip. The frame may generally indicate a plastic area of the cartridge that the lube ring may be disposed onto and may surround the blades, while the housing may generally signify the plastic structure securing the blades prior to their placement in the frame. The clips are generally metallic pieces typically placed on the ends of the razor blades for securing the blades together in the housing. The cartridge connecting structure is an intermediate structure connecting the razor cartridge with a razor handle.

### Lubricating Body

A “lubricating body” in the present invention is one of the razor cartridge components listed above and may include, but is not limited to, a solid shaving aid material in the form of a lubricating strip (oftentimes referred to as a “lubrastrip”), a soap or gel (e.g., wings with gel bars or soap wings), a lubrication ring (oftentimes referred to as a “lube ring”), a foam embedded with a shaving aid material or any other lubricious composition or formulation, or any combination thereof.

Any desired formulation may be used for the shaving aid material. Desirably, the shaving aid material has sufficient wear resistance so that the lubricating body lasts for about the intended life of the cartridge. However, the shaving aid material may also be exhausted before it is necessary to replace the cartridge.

In the present invention, as will be described in more detail below, the erodible label disposed on a lubricating body or other razor cartridge component may include an added fragrance by placement of one or more drops of fragrance or scented oil, beads or creme.

In some instances (e.g., with gel bars or soap wings), the shaving aid material used may include soap (e.g., poured or extruded soap). Such soap-based compositions may be modified to increase their hardness, wear resistance, lubricity and/or skin moisturizing and conditioning properties. For lubricating strips (lubrastrips), which are generally extruded, the shaving aid material desirably comprises a polymeric material, generally a lubricious water-soluble polymer, such as polyethylene oxide, which leaches out of the strip during shaving to enhance shave comfort and optionally a water-insoluble polymer, typically polystyrene. Adding a polycaprolactone material may improve the fabrication of the shaving aid strip, provide smoother strip surfaces and permit the inclusion of greater amounts of water-soluble polymer in the strip to cause a release of more shaving aid during use. For lubrication rings (lube rings) which are generally injection molded, the shaving aid material generally comprises a similar composition of polymeric material as described above for lubricating strips.

The present invention also contemplates lubricating bodies disposed on any other razor cartridge component or portion thereof (e.g., where shaving aid material or any lubricant material or other formulation is coated or disposed on an exterior surface of the razor component).

### Erodible Label Composition

The erodible label of the present invention has a label composition which is comprised of polyethylene oxide (PEO), polyvinyl alcohol, polyvinyl pyrrolidone, polyurethane, polyacrylate, polyureas, polyalkylene glycols, cellulose based polymers, or any combination thereof. The erodible label may also further comprise scents, thermo-chromic pigments, lipids, waxes, moisturizing agents, exfoliating agents, inorganic salts, holographic inks, marbleized inks, hair growth retardants or inhibitors, or any combination thereof.

Generally, a desirably aspect of the erodible label of the present invention is that the label is predominantly comprised of about 10% to about 100% by weight of composition of one or more water soluble polymers.

### Erodible Label Provides Benefits

A “functional benefit” of the erodible label of the present invention pertains to having an advantage communicated to or obtained by a user (or prospective user or consumer) before, during or after the operation or use of the razor product (e.g., while shaving) involving, or concerned with the functionality or usage of the product. This functional benefit may be communicated to a user at the point of purchase (e.g., before use or when choosing a product). For instance, a user may determine that a product has a functional benefit based on the label on the razor product in a razor package displayed on a store shelf. The functional benefit may be obtained by the user during use as well. For instance, the functional benefit desirably may include a faster leaching or wear time or an increased release of lubricant or having a scent released from indicia disposed on an exterior surface of a lubricating body or other component of a razor cartridge.

### Leaching Benefit

“Leaching” as used herein may be generally defined as the release of lubricant or soluble constituents from a lubricating body. In addition to the lubricating bodies described above (e.g., in the case of porous lubricating rings or strips made from a matrix of polyethylene oxide, oftentimes referred to as “polyox” or “PEO” and polystyrene, the leaching of a lubricating ring or strip may signify the dissolving out or the release of constituents such as the PEO or in the case of an impregnated foam or sponge type of lubricating body, the leaching or release of lubricant generally occurs from the pores of the impregnated foam or sponge), the label of the present invention may be thought of as an additional lubricating body or providing the benefits of a lubricating body in terms of release of lubricant or soluble constituents (e.g., a wearing away) in terms of improved shaving attributes such as comfort and glide and moisturization.

The erodible label may also wear by a certain amount per wet shave. The amount of wear may range anywhere from about 10% to about 75% per wet shave. The wearing away may be measured by any and all label dimensions, though the reduction in a thickness dimension will be described herein. Each wet shave may desirably range, on average, from about 200 to about 250 strokes. The erodible label may desirably wear off completely from the exterior surface of the razor cartridge component after about 2 shaves to about 10 shaves. Naturally, the number of shaves or the percentage wear may vary as a result of the ingredients in the label composition, and other user variable factors, such as amount of force on the skin, days between shaves, hair type, and the surface area to be shaved. A wet shave generally signifies a shave where water and/or a shave preparation will be used.

Depending on the composition of the label, another benefit of having an erodible label of the present invention may arise where the erodible label of the present invention operationally provides hair improvements such as but not limited to, hair minimization or hair reduction. Additionally, the label may serve to provide a user with the functional benefit of providing skin moisturization, acne-reduction or any other skin improvements during and/or after use.

An “aesthetic benefit” of the erodible label of the present invention pertains generally to an advantage communicated to or obtained by a user (or prospective user) before, during, or after, operation or use of the razor product involving, or concerned with pure emotion and sensation as opposed to pure intellectuality and may include one or more aspects of beauty. In many instances, this aesthetic benefit may be a pleasing sensation or emotion provided to a user (e.g., a feeling or opinion that a product is appealing or attractive, that it may be easy or fun to use, that it may be safe for sensitive skin, etc.) by the product at the point of purchase (e.g., before use). However, an aesthetic benefit may be obtained by the user during use as well. For instance, the aesthetic benefit of a pleasing scent or other sensation may be realized as the user is operating the razor. Additionally, the label may serve to provide a user with the aesthetic benefit of skin that looks good or appears moist or otherwise improved after such use.

The aesthetic or functional benefits described herein may be achieved in the present invention without requiring a new routine, a new way of thinking, or extra work for the consumer.

Furthermore, the label may also beneficially minimize any confusion or guesswork about a razor's attributes or may inspire the user to be more attentive to the characteristics of the razor and how the razor feels against their skin during use.

### Labels as Cue or Indicia

In the present invention, the erodible label may serve as a “cue” desirably providing a hint, signal or indication or identification of an experience, or may act as an “indicium,” (or “indicia” in its plural form), signifying one or more discriminating marks, signs, tokens, indications, or appearances on a razor cartridge component (e.g., a lubricating body).

The label of the present invention desirably provides and/or conveys one or more “functional” benefits and/or one or more “aesthetic” benefit(s) to a consumer. In many instances, the label may correspond to characteristics or benefits of the razor cartridge components and thus may assist in communicating these characteristics or benefits to a consumer or user.

Several examples of types of labels offering functional and aesthetic benefits, cues or indicia, disposed onto a portion of the exterior surface of a razor cartridge component, such as, but not limited to, a lubricating body of a razor cartridge, are described below in accordance with the present invention.

### Types of Labels

Generally, labels of the present invention may include, but are not limited to, one or more graphic, pattern, design, text, fragrance, or any combination thereof. Graphics may include pictures (e.g., a man's or woman's face), logos, images, shapes, or charts or any combination thereof. An indicium may generally be anything, such as for example, a water droplet, a flower, a bubble, or a sparkle. A group of water droplets or other indicia may form a pattern or design. A pattern may include one or more decorative or ornamental markings (e.g., water droplets, flowers, bubbles, sparkles, etc.) where such markings may be repeated or combined with other patterns. Designs may include sketches or artworks of flowers, vines, lace, or any other desirable schemes or combinations thereof. Text may include any writings with letters, numbers, or symbols or any combination thereof. The labels of the present invention are not intended to cover known prior art color-changes on lubricating strips or other lubricating bodies. The labels of the present invention may also be geared to a particular demographic, age group, (e.g., young men or teenage or pre-teen girls) or country and could also include, for instance, a hologram for showing a three dimensional image or the label of the present invention may include a fragrance or scent.

### Label Transfer Technologies

Label transfer technologies as used herein signifies the process involved to transfer a label onto a substrate. In some cases, the transfer will occur with the use of a carrier film carrying the label prior to its transfer to the substrate. After transfer of the label to the substrate, the carrier film is removed. In other processes, the label transfer to the substrate may occur without the use of a carrier film; this is oftentimes referred to as a direct transfer. Some technologies may allow for transfer of the label either with or without a carrier film.

Curing is a step used in any of types of label transfer technology processes and may occur prior to or after the transfer of the label. As used in the present invention, it generally signifies the process of toughening or hardening the label formulation, generally a polymer based formulation, such as those found in inks by cross-linking the polymer molecule chains. The curing process in the present invention may be achieved by heat, UV (ultra violet) radiation, or EB (electron beam) radiation, or any combination thereof. As it is known in the art, during the process of curing, any extraneous solvents not required in the cross-linking process are generally removed. In the prior art, after curing, the transferred label becomes generally permanently disposed on the substrate.

One known type of label transfer technology is a heat transfer label process, a process where inks are printed onto a carrier film (made of polyethylene oxide or a bi-axially oriented polypropylene or BOPP) and subsequently transferred directly to a desired surface by applying pressure P (at about 20 to about 40 psi) and heat H (at temperatures ranging from 100 to 320 degrees Celsius) during a short interval of time T (times that vary between less than about 0.1 second to about 1 second).

In addition to heat transfer label technology, screen printing and roll coating technologies are other types of label transfer technologies that may be used as a method to transfer one or more labels onto an exterior surface of a substrate in the present invention. Screen printing involves inks which are generally forced through a mesh and applied onto a desired surface. Roll coating consists of the application of a thin film onto a desired surface by rolling or turning a roll wetted with the ink. In general, screen printing and roll coating technologies do not require heat to be applied and these technologies may or may not require a carrier film to transfer the ink to a substrate. If a carrier film is not required, oftentimes this is referred to as a direct transfer.

Flexographic type label transfer processes generally involve a system of printing on a rotary press covered by a flexible relief plate, employing solvent or water-based ink, used especially for printing on plastic, paper, or cardboard.

Rotogravure generally involves printing by an intaglio printing process in which letters and pictures are transferred from an etched copper cylinder to a web of paper, plastic, or similar material in a rotary press. Generally, flexographic type and rotogravure label transfer processes may require a carrier film and heat to transfer the label to a substrate. Other label transfer processes if known in the art are also contemplated in the present invention.

Labels of the prior art are generally made of ink which is substantially non-water soluble and includes materials such as polyesters, polyurethanes, epoxies, or polyacrylates. or any combination thereof. In addition, the labels thus produced from the types of label transfer technologies described above are generally permanent after curing or drying. In fact, the concept of producing a temporary label is generally not desired in the prior art as once the label (e.g., decoration, etc.) is applied it is intended to be preserved or maintained. For instance, silk-screen processes are commonly used to place a design type label on T-shirts where the design label is intended to be preserved even after repeated washing and wearing of the T-shirt.

In one prior art reference, U.S. Pat. No. 3,891,581, entitled Water Dilutable Transfer Ink Compositions which issued on Jun. 24, 1975, a water-dilutable ink for use with heat transfer processes is described for textile fabrics and the like. While providing ease of use and ease of cleaning of equipment, this prior art reference describes a permanent label, enduring on the fabric over time. Furthermore, the polymers that make up the ink composition of this prior art reference are not actually transferred onto the substrate to be labeled, but rather it is the pigment of the ink which is transferred via a process called sublimation which allows the label to endure on the fabric over time even if washed.

The types of labels found in the prior art are generally in direct contrast to the novel erodible label disposed on razor cartridge components of the present invention, which will be described in more detail below.

Thus, the present invention is directed to a novel label transfer process (e.g., heat transfer labeling) where the ink of the label is substantially a water-soluble polymer.

Additionally, the present invention is directed to a novel label formed using the novel label transfer process wherein the label formed is erodible (e.g., not permanent), wears away with use (e.g., number of shaves), or dissolves in water.

Still further, the present invention is directed to the benefits of the label formed by the novel label transfer process. These benefits can be categorized into functional benefits and aesthetic benefits as defined herein and as described in detail in prior pending patent application, Ser. No. 12/629,249, entitled “Razor Cartridge Components With Indicia,” filed Dec. 2, 2009, assigned to the Assignee hereof.

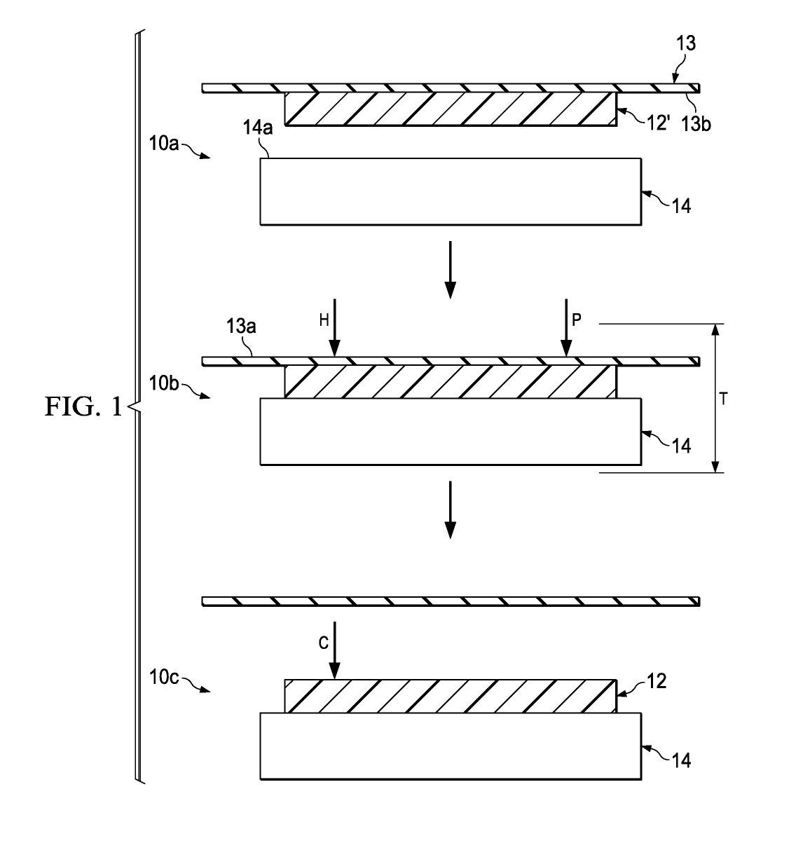

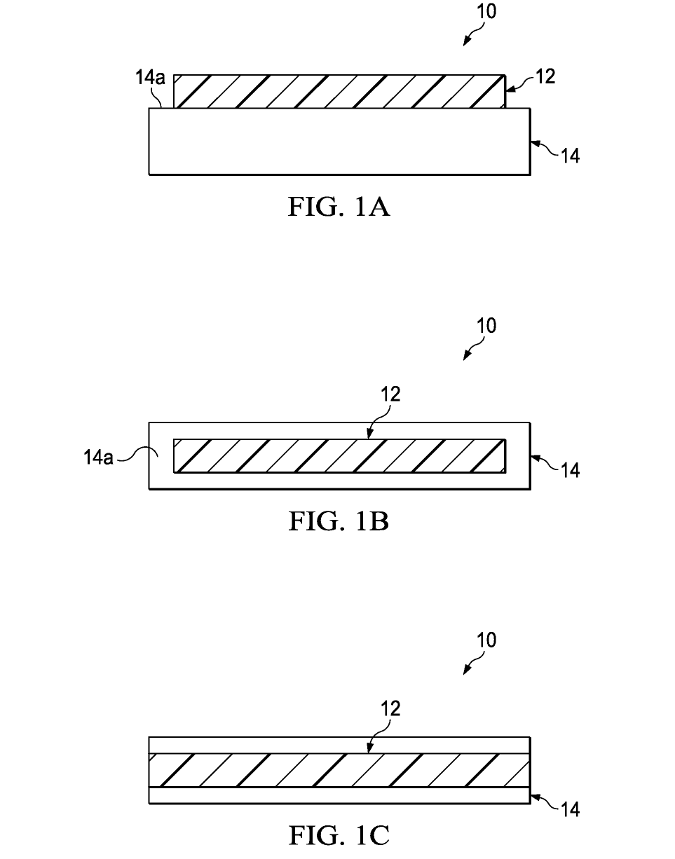

Referring now to the flow diagram of FIG. 1, a novel label transfer process (e.g., heat transfer labeling) is described where the composition of the label is substantially comprised of a water-soluble polymer, such as PEO in accordance with the present invention.

At step 10a, a pre-transfer label 12′ is shown affixed to a bottom surface 13b of a carrier sheet 13. Carrier sheet 13 may be in a roll format (not shown). The process of transferring pre-transfer label 12 to substrate 14, forming a post-transfer or final label 12 includes, as shown at step 10b, applying heat H and pressure P to the upper surface 13a of the carrier sheet 13, as shown in FIG. 1 for a time T, where heat, pressure and time parameters and conditions are desirably similar to those described above with regard to heat transfer label processes. After the requisite heat H, pressure P and time T conditions have been satisfied, the carrier sheet 13 will then be removed (e.g., desirably automatically rolled off, but also may be manually removed) from the pre-transfer label 12′ and post-transfer or final label 12 will be left on to the exterior surface 14a of substrate 14 as shown at step 10c. A curing step C of label 12 may occur after it is disposed on the substrate 14 as shown in step 10c. Alternatively, the curing step C of the label 12 may have occurred prior to step 10a or at the point of forming the label 12′ onto carrier sheet 13 (not shown).

While a heat transfer process is described herein, the label 12 may be disposed onto the substrate using any other label transfer processes which may involve a pressure P, with or without heat H, such as silk screen processes or roll coating processes and with or without a carrier film as also described above, or any other feasible transfer process, or any combinations thereof.

Once the label 12 has been applied to the substrate 14, the carrier sheet 13 may thereafter desirably be thrown away.

Even after heat, pressure and curing, label 12 will desirably not be permanent as will be described below.

In FIG. 1A, a component 10 is shown including the label 12 of FIG. 1 disposed on an exterior surface 14a of substrate 14 in accordance with the present invention.

Label 12 is desirably substantially comprised of one or more water soluble polymers. It may be desirable that label 12 be substantially comprised of one type of water soluble polymer, such as polyethylene oxide (PEO). Label 12 of the present invention will generally include from about 10% to about 100% by weight of composition of a water soluble polymer.

The present invention contemplates that label 12 may also be comprised of polyvinyl alcohol, polyvinyl pyrrolidone, polyurethane, polyacrylate, polyureas, polyalkylene glycols, cellulose based polymers, or any combination thereof. Label 12 may also further include scents, thermo-chromic pigments, lipids, waxes, moisturizing agents, exfoliating agents, inorganic salts, holographic inks, marbleized inks, hair growth retardants or inhibitors, or any combination thereof. In some instances, the label may comprise ingredients that are found in typical shaving aid materials.

Desirably, substrate 14 may be at least a portion of one or more razor cartridge components which may generally include at least one of the following: a lubricating body, a cap, housing, a frame, a clip, a guard, a razor blade, a cartridge connecting structure, or any combination thereof. For instance, substrate 14 may be a lubricating body such as a lubrication ring (e.g., lube ring) or a lubricating strip (e.g., lube strip) or a hard plastic substrate (e.g., frame), or any combination thereof.

The exterior surface 14a of the substrate 14 and the substrate 14 may be generally be made of a hard plastic substrate, a lubrication formulation, a metal, a rubber, a wood, a non-woven material, bamboo, or any combination thereof. In the present invention, the exterior surface 14a and the substrate may or may not be made of the same material.

A top view of FIG. 1A is shown in FIG. 1B, where label 12 is depicted covering a substantial portion of the exterior surface 14a of substrate 14 but not the entirety of the exterior surface 14a of substrate 14 in accordance with one aspect of the present invention. It should be noted however that label 12 may cover the entire exterior surface 14a of substrate 14 or almost the entire exterior surface 14a of substrate 14 (as shown in FIG. 1C) in accordance with another aspect of the present invention and thus, label 12 may have substantially equivalent surface area as the substrate 14 it is disposed on.

The present invention is also directed to the novel label formed using the novel label transfer process of FIG. 1 wherein the formed label is erodible (e.g., not permanent), wears away with wet shaving use, or dissolves in water. Generally, label 12 may desirably include ingredients typically found in lube rings and/or lubrastrips of traditional razor cartridges. For instance, a lube ring is typically made of a blend of polyethylene oxide (PEO) and polystyrene, which when wetted during shaving, are capable of providing lubrication and moisturization to a user. As it is known in the art, the lube ring also typically wears away from one shave to the next.

Since label 12 of the present invention is made of polyethylene oxide (PEO) or in some cases, almost exclusively of PEO, label 12 thus includes a similar chemistry as the lube ring (e.g., based on having one of the components of the lube ring blend—the PEO) and desirably exhibits similar properties when wetted during shaving. Thus, the label 12 itself will also desirably provide added lubrication and moisturization to a user's skin, and much like current lube rings and lube strips, label 12 of the present invention may desirably be an erodible label, wearing away during wet shaving since label 12 will desirably dissolve when in contact with water in a similar fashion as the PEO from the lube ring on a cartridge does.

However, label 12 of the present invention may desirably wear away at a faster rate (e.g., increased leaching per shave) than current lube rings or lube strips because of the greater amount of water-soluble polymer or in this particular embodiment, a greater amount of PEO. Thus, a label may wear, shave to shave, anywhere from about 10% to about 75% from its initial size (e.g., thickness or height).

Additionally, unlike current lube rings and lube strips, it is desirable that label 12 may, to a large extent or substantially completely erode or wear away after a certain number of shaves, leaving the exterior surface 14a of the substrate 14 exposed. Therefore, the label may, if desired, be used as a cue or indicator of consumption signifying it is almost time or time to change the cartridge.

Depending on the type of label desired, the erodible label of the present invention may have relatively varying dimensions and locations on the exterior surface of a razor cartridge component.

The width of one erodible label may desirably range from about 0.5 mm to about 45 mm, the length may desirably range from about 0.5 mm to about 11 mm, and the height may desirably range from about 0.001 mm to about 5.00 mm, more desirably ranging up to about 3.00 mm, and most desirably up to about 1.00 mm, above the exterior surface of the razor cartridge component. Moreover, by varying the location, thickness, and other characteristics of the label, the amount and lubrication and leach rate may also likely vary.

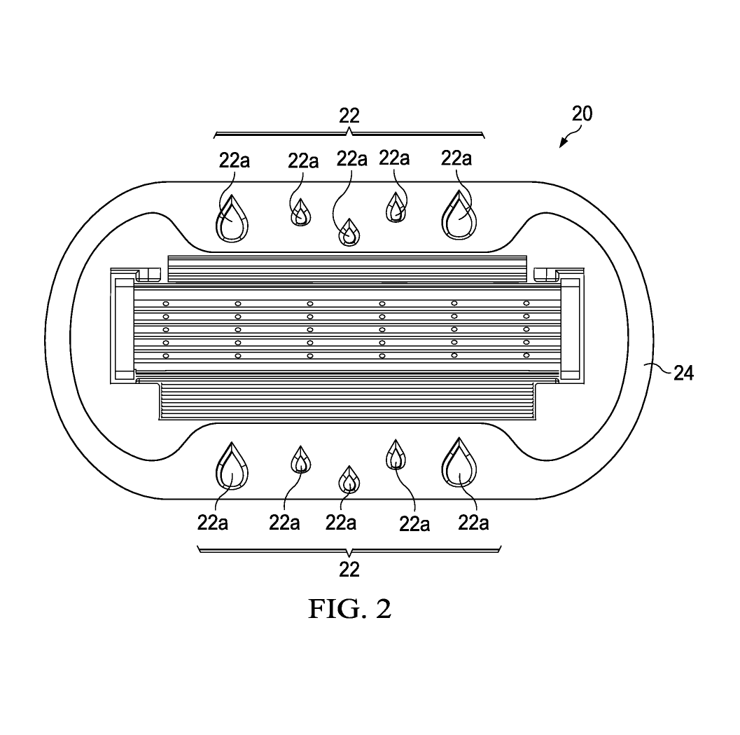

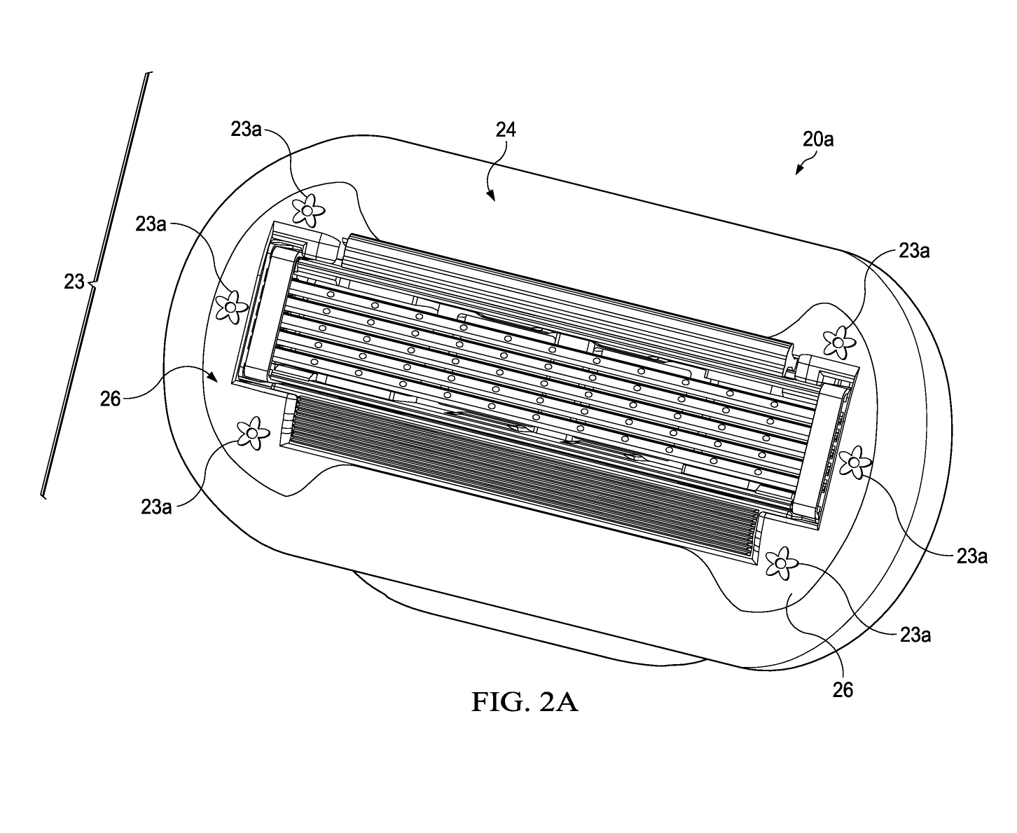

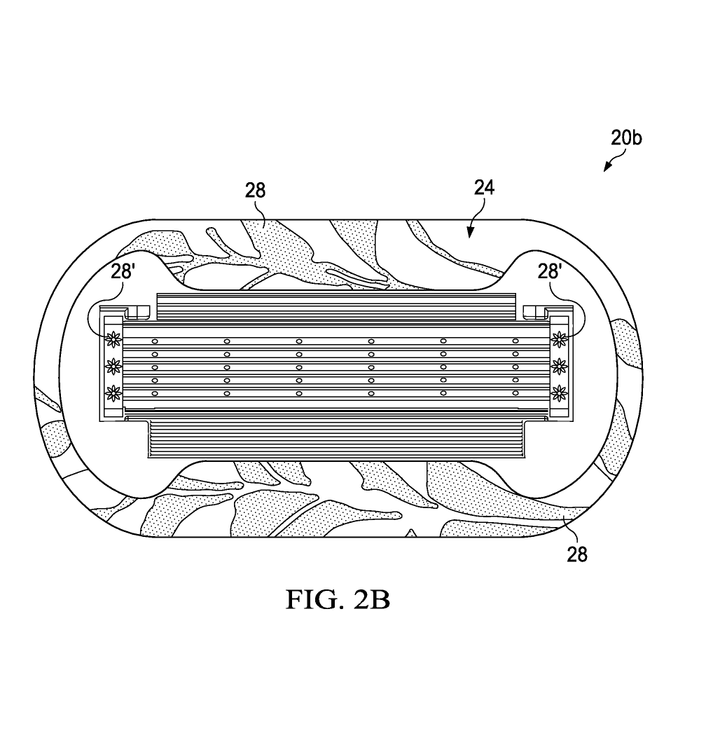

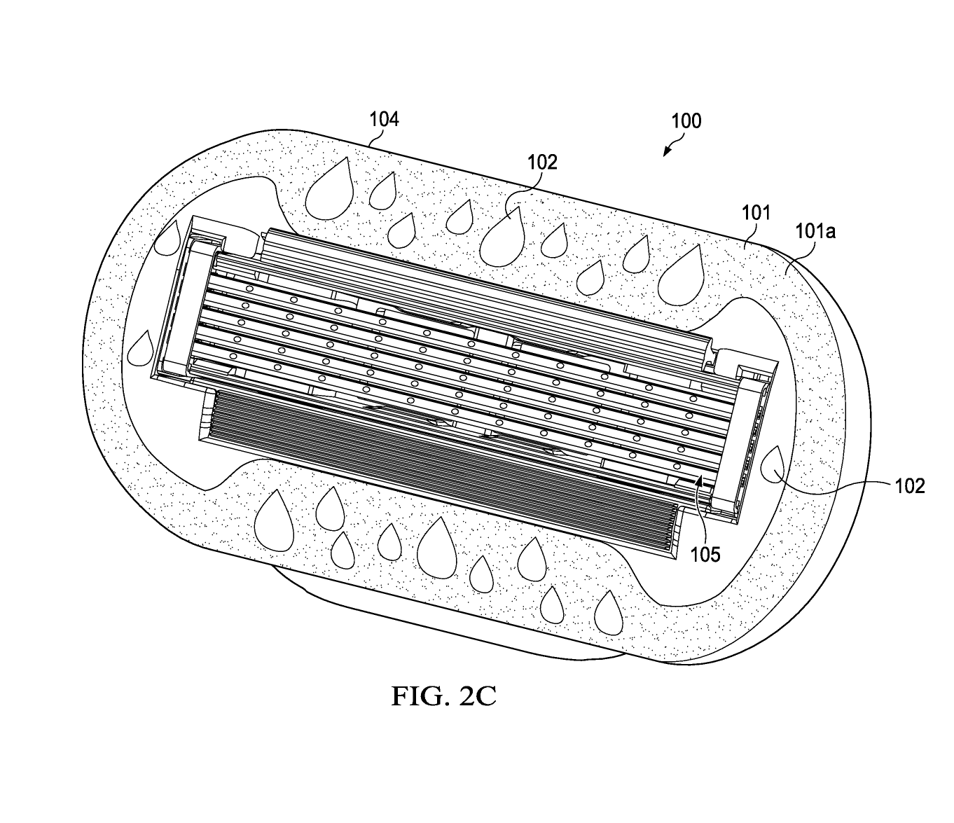

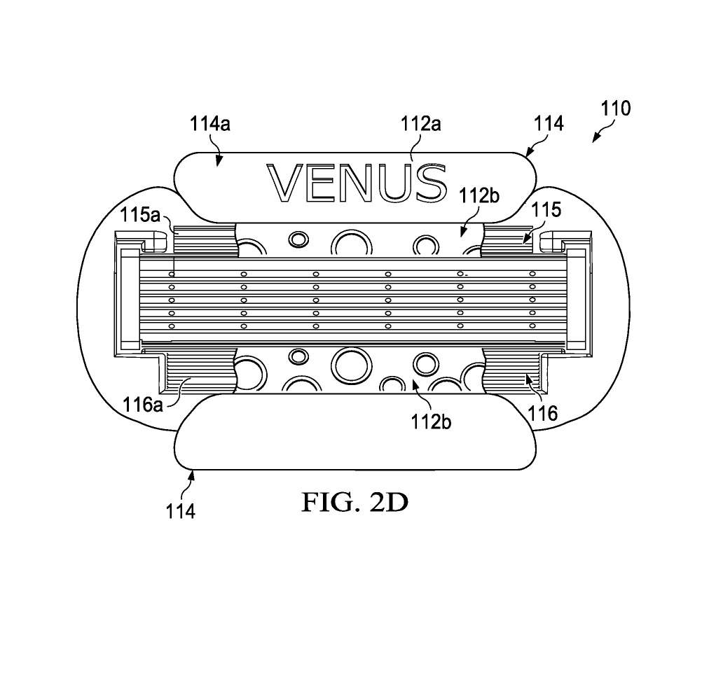

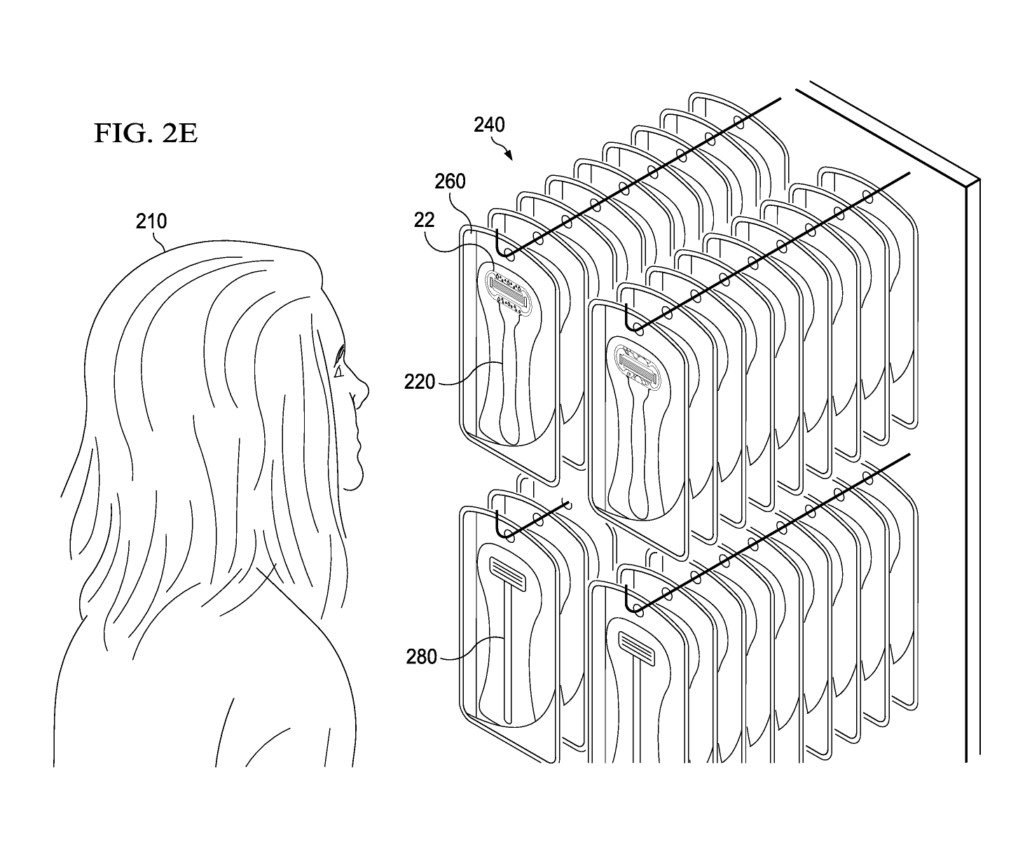

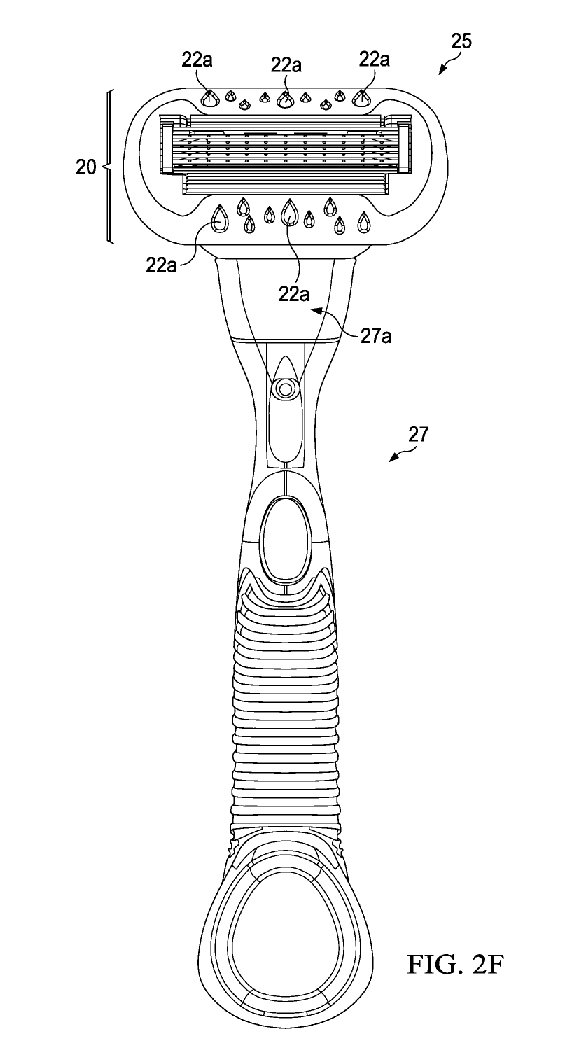

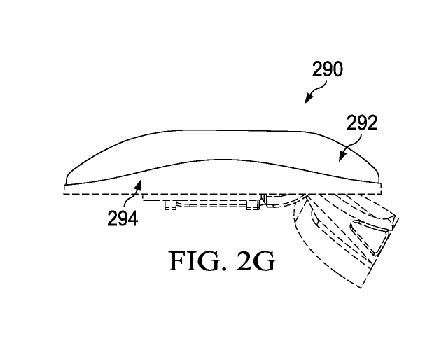

In addition to providing an increased leach rate, the label of the present invention may also provide functional and aesthetic benefits. For instance, the label may be decorative, may provide a cue or indicia. Such a label is shown in FIG. 2 where a razor cartridge 20 is depicted having a label 22 including a design comprising multiple individual water droplets 22a arranged on an exterior surface 24a of substrate 24. Substrate 24 may desirably be a lube ring. Label 22 is placed on substrate 24 via label transfer technology (e.g., heat transfer label) desirably simultaneously covering the desired portions of the exterior surface 24a of lube ring 24 in accordance with the present invention.

The water droplets of the water droplets label 22 may serve as indicia letting a user know that the lube ring will function to provide lubrication and/or moisture. The water droplets 22a will during shaving over time and may wear away completely after several shaves.

The functional benefit of the water droplet label 22 (e.g., moisturization or lubriciousness) may be communicated to the user at that point in time and with that, a functional benefit may also be communicated to the user even before use.

Not only do water droplets 22a on lube ring 24 provide functional benefits to the user, they may also communicate several aesthetic benefits to the user. The water droplet pattern in razor cartridge 20 may communicate a pleasing sensation to the user before, during or after use of the razor. Label 22 for instance, may provide a user the notion that the razor product is safe to use for sensitive skin or that the razor is otherwise appealing. During use, the label 22 may emit a pleasant scent or fragrance to the user providing another aesthetic benefit if the formulation includes a fragrance.

However, a significant advantage of using label transfer technologies for providing an erodible label on any razor cartridge component (e.g., the lube ring) is the ease with which one may change the label or the design of the label as desired. If a design change is desired, there is no need for costly and time-consuming injection mold changes or other different or new machinery such as cavities and cores for molds which are often used for components such as lube rings and gel bars. The ability to change a label's design is a simple matter of changing the screens or plates that are used in the printing processes. This allows the submission of new rolls of labels with new artwork. This change is much simpler and less time consuming than producing, at the outset, new or changed molds or new machinery. Further, any number and any type of label may be implemented in the present invention, some of which will be described below.

FIG. 2A depicts an alternate embodiment of the present invention showing a razor cartridge 20a including an erodible label 23 disposed on a frame 25 of the razor cartridge 20a. Erodible label 23 is depicted as including individual flowers 23a. Frame 25 may desirably be made of a hard or rigid plastic material such as polypropylene, polystyrene, high impact polystyrene, poly (phenylene oxide), polyoxymethylene, acrylonitrile-butadiene-styrene polymer (ABS), or any combination thereof. In addition to a functional (e.g., lubriciousness) benefit, flowers 23a of label 23 may provide an indicia that the cartridge will exude a pleasant fragrance. Aesthetic benefits conveyed by the erodible label 23 to a user may include a desirable, pleasant feeling of flowers. For instance, flowers look comforting, natural, sensitive, and design 23 has appealing shapes which exude a fresh, spring-like feeling. Additionally, if a fragrance or moisturization ingredients are provided within the label 23, thereby giving off a nice scent to the user, both aesthetic and functional benefits of label 23, during shaving, may be realized.

FIG. 2B depicts an alternate embodiment of the present invention showing a razor cartridge 20b including an erodible label 28 disposed on a lube ring 24 of the razor cartridge 20b and an erodible label 28′ disposed on the outer surface of the metal clips. Erodible label 28 forms a floral or vine-like pattern desirably using marbleized inks. Both labels may be formed using label transfer technology such as heat transfer processes either desirably simultaneously in one process or in two serial processes (e.g., first the label on the clips and then the label on the lube ring).

Aesthetic benefits conveyed by the erodible label 28 to a user may include a desirable, pleasant feeling of flowers. For instance, flowers look comforting, natural, sensitive, and design 28 has appealing shapes which exude a fresh, spring-like feeling. Label 28 may also include gold, silver, or other colors which may generally be deemed luxurious and may convey a high-end feeling and be marketed for a particular demographic. Additionally, if a fragrance or moisturizing ingredients are provided within the label, thereby giving off a nice scent to the user, both aesthetic and functional benefits of label 28, during shaving, may be realized.

By being shiny, reflective and/or sparkly, erodible label 28′ may afford the user with aesthetic (e.g., pleasing) benefits indicating that the cartridge is clean and new.

These benefits may be communicated to a user at the retail store if the labels are visible in the razor package displayed on the store shelf or during the first or subsequent uses at home.

In addition to lubricating bodies and clips, the novel aspects of the present invention of may be desirably disposed on other razor cartridge components similarly, such as portions of at least one of the following other razor cartridge components, such as a guard, a cap, a housing, a razor blade, a cartridge connecting structure, or any combination thereof.

FIG. 2C depicts a razor cartridge 100 showing erodible label 102 incorporated onto an exterior surface 104 of a foam 101 in accordance with the present invention. Foam 101 may be embedded with lubricating fluid (not shown) which leaches from pores 101a and foam 101 may, as shown, surround the circumference of razor blades 105 entirely. Label 102 is depicted as water droplets that may be desirably disposed on the exterior surface 104 with the label transfer technologies described herein. Label 102 may provide both aesthetic (e.g., pleasing) and functional benefits when these benefits are communicated to a user based on the erodible label 102 being visible on the razor product in a razor package displayed on a store shelf and after repeated uses at home. Additionally, the erodible label 102 as it leaches lubricant during shaving may serve to provide a user with the functional benefit of providing skin moisturization or other skin improvements during and/or after use.

FIG. 2D depicts a razor cartridge 110 showing erodible label 112a disposed onto an exterior surface 114a of a soap wing or gel bar 114 in accordance with the present invention via at least one type of label transfer technology. Label 112a is depicted as text as for instance including the word VENUS, (e.g., representing Venus®, a trade name). Erodible label 112b is generally depicted as patterns of bubbles disposed onto exterior surfaces 115a and 116a of lube strip 115 and guard 116, respectively. The labels 112a and 112b may both provide aesthetic and functional benefits, cues or indicia. For instance, the bubbles label 112b may provide indicia and/or aesthetic benefits to a user before or during use may include exuding an appealing, pleasant feeling of bubbles in water, a relaxing bath-time, a moisturizing, soothing experience, and/or a fresh clean feeling. Functional benefits of label 112b on the lube strip during use may conceivably include an increased leach rate.

Additionally, by providing moisturization to a user's skin, both aesthetic and functional benefits of label 112b, during and/or after shaving, are realized. The erodible label 112a may serve as a cue as to the source of the goods or quality and/or provide an aesthetic benefit in that a pleasant feeling of a goddess is revealed while shaving.

If the labels are transparent or partially transparent (e.g., a cartridge showing through a package window) in a razor package, a user is provided a visual cue of the razor cartridge in its package on display in a store. This scenario, providing visibility to a consumer 210 of the labels on razor product 220 displayed on a store shelf 240 at a poignant decision moment (e.g., which product to purchase), is shown in FIG. 2E where a consumer or prospective user 210 is depicted in a store aisle 200 detecting or viewing the erodible labels such as those described herein (label 22, 23, 28, or 28′ for instance) disposed on the razor product 220 but observable from the interior of the packaging 260. The erodible labels, having provided aesthetic and/or functional benefits, cues or indicia to consumer 210, may conceivably offer the extra impetus for consumer 210 to decide to purchase product 220 rather than deciding to purchase a different product 280 (e.g., competitor's product) also displayed on (or proximal to) the shelf 240 which do not have erodible labels. Moreover, such visible labels also provide a beneficial means of debuting and conveying new features or characteristics on new razor products to the user by a razor manufacturer.

FIG. 2F depicts a razor or razor product 25 where razor cartridge 20 of FIG. 2 is operatively coupled to a top portion or cartridge connecting structure 27a of a razor handle 27. Razor 25 of the present invention is contemplated as being any type and as such, may be a male, female, disposable or permanent (e.g., system) type razor product.

As a further extension to the present invention, an alternate embodiment is shown in FIG. 2G where the label transfer technology may be utilized to form an erodible label which may be utilized as a substitute for an entire lubricating body of a razor cartridge rather than, as in FIG. 2, disposed only on an exterior surface of a lubricating body (e.g., lube ring). This may be accomplished by the same label transfer processes mentioned herein utilizing. In FIG. 2G, a side view of cartridge 290 is depicted showing an erodible label 292 disposed onto an exterior surface of a frame or housing 294 (e.g., the substrate) to form the lubricating body. The thickness of erodible label 292 may desirably range up to 5.00 mm being desirably formed using a heat transfer label process where the “ink” of the label comprises a composition from about 10% to about 100% by weight of composition of one or more water soluble polymers. By transferring a very thick erodible label onto the frame or housing the label 292 desirably may take the place of or form the lube ring of the razor cartridge 292. It follows that the composition of the erodible label 292 may vary according to its desired wear.

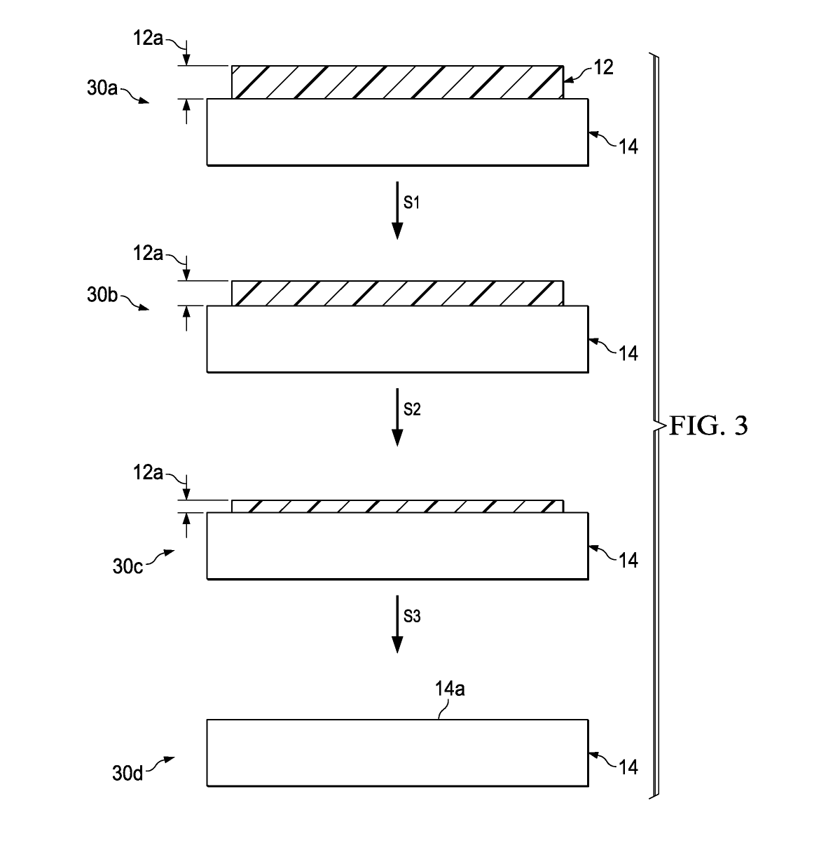

FIG. 3 depicts a label 12 disposed on a substrate 14 as finally formed at step 10c in FIG. 1 where the substrate 14 may desirably be a lube ring of a razor cartridge (such as lube ring 24 of FIG. 2) and the label 12 may be comprised of any water soluble polymer formulation described herein. FIG. 3 depicts a flow diagram, where the label 12 on the lube ring will desirably wear away or erode after multiple wet shaves.

The present invention contemplates that the number of shaves that occur for the label to wear away completely may range anywhere from about 2 shaves to about 10 shaves on average, each about 200 to about 250 strokes and in some cases more or less, where each shave is a wet shave or performed with water and/or other shave preparation.

For simplification, S1, S2, and S3 of FIG. 3 are intended to signify a 1^{st} Shave 1, a 2^{nd} Shave, and a 3^{rd} Shave, respectively, with each wet shave S1, S2, and S3 desirably ranging, on average, from about 200 to about 250 strokes (or more or less).

Starting at step 30a of FIG. 3, the thickness 12a of the label 12 may initially be in the range of from about 0.001 mm to about 5.00 mm, and preferably at about 0.10 mm to about 0.30 mm.

At step 30b, which occurs after S1, (e.g., about 200 strokes to about 250 strokes), it can be seen that the thickness 12a of label 12 may be reduced from that at step 30a by about 10% to about 75%.

At step 30c, which occurs after S2, (e.g., about 200 strokes to about 250 strokes which occur subsequent to and in addition to S1's strokes), it can be seen that the thickness 12a of label 12 may be reduced from that at step 30b by about 10% to about 75%.

At step 30d, which occurs after S3, (e.g., about 200 strokes to about 250 strokes which occur subsequent to and in addition to S1 and S2' s strokes), the thickness 12a of label 12 may be substantially reduced to zero.

Though only 3 consecutive shaves are depicted in the flow diagram of FIG. 3, the present invention also contemplates any number of shaves (typically up to about 10 shaves or about 2000 to about 2500 strokes) in which the erodible label may wear away completely. The composition of the erodible label plays a big role in the leach rate of the label. Generally, with more PEO present in the label composition, the label leach rate increases and thus the label itself may wear at a faster rate. The presence of other polymers with a high solving rate in water, such as poly (vinyl alcohol) (PVA), may also increase the leaching and thus, the wearing away of the label.

It is further contemplated in the present invention that the erodible label may wear away, but not completely before the cartridge is disposed of. At step 30d of FIG. 3, for instance, the thickness 12a of label may be from about 0.01 mm to about 0.05 mm.

In general, after the label 12 wears away completely, the substrate 14 (e.g., lube ring) or its exterior surface 14a will be exposed. The user may still use the razor cartridge after the label 12 has completely eroded if the lube ring is still present and viable.

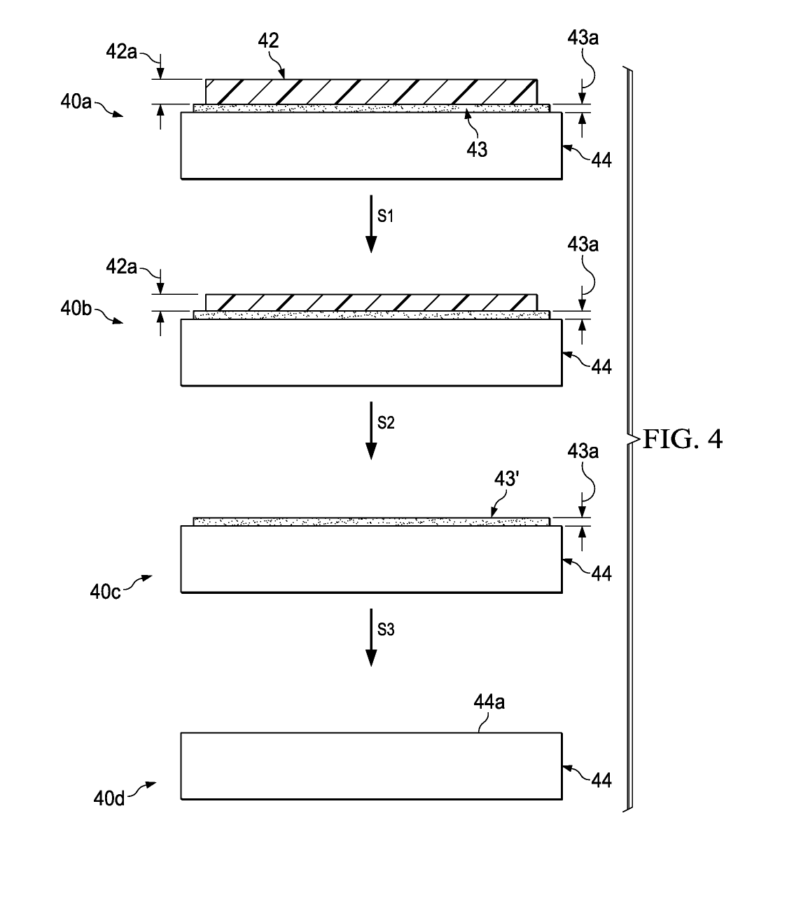

Referring now to FIG. 4, a label 42 which may desirably be formed via label transfer technology such as heat transfer processes and disposed onto a substrate 44 is shown in accordance with another aspect of the present invention having an adhesive layer 43 disposed therebetween.

The substrate 44 may be a lubrication ring or lubrastrip of PEO or PEO mixtures or may be a hard plastic such as a frame of a razor cartridge.

Adhesive layer 43 may desirably act as an adhesive seal and is desirably comprised of water insoluble polymers such as acrylic polymers, up to about 70% by weight of composition or include other materials which will assist in adhesion and additionally, water soluble polymers similar to those described for the erodible label, up to about 70% by weight of composition. The adhesive layer may additionally comprise a resin or glue. The composition of the adhesive layer may also generally vary depending on the type of substrate it is being disposed on. For instance, if the substrate is such that substantial amounts of water soluble polymers are not sufficient to bond to the desired substrate, then the amounts of water insoluble polymers may generally increase in the adhesive layer composition. Thus, while the adhesive layer may desirably have a substantial amount of water soluble polymers, much like the erodible label itself, the adhesive layer of the present invention may desirably be of a different composition than that of the label 42 and while it is intended to also wear away, it may generally not wear as quickly as the label itself.

The formation of label 42 with adhesive layer 43 on the substrate may desirably occur simultaneously in a label transfer process, such as a heat transfer label transfer process, as described above with regard to FIG. 1.

In the flow diagram of FIG. 4, label 42 and adhesive layer 43 each have initial thicknesses 42a and 43a, respectively.

As before with FIG. 3, S1, S2, and S3 of FIG. 4 are intended to signify a 1^{st} Shave 1, a 2^{nd} Shave, and a 3^{rd} Shave, respectively, with each wet shave S1, S2, and S3 desirably ranging, on average, from about 200 to about 250 strokes (or more or less).

Starting at step 40a of FIG. 4, the thickness or height of label 42a of the label 42 may initially be in the range of from about 0.001 mm to about 5.00 mm, and preferably at about 0.50 mm while the thickness 43a of the adhesive layer 43 may range from about 0.001 mm to about 0.10 mm and preferably from about 0.025 mm to about 0.040 mm. Generally, the adhesive layer may desirably not be as thick as the label itself.

Referring now to FIG. 4 at step 40b, which occurs after S1, (e.g., about 200 strokes to about 250 strokes), it can be seen that the thickness 42a of label 42 may be reduced from that at step 40a by about 10% to about 75% while the thickness 43a of adhesive layer 43 desirably remains the same.

Generally, because the adhesive layer is beneath the label, it will not wear until the label has worn away or eroded completely. Additionally, the thicknesses of label 42 and adhesive layer are about the same after a certain number of shaves as for instance depicted herein at step 40b.

At step 40c, which occurs after S2, (e.g., about 200 strokes to about 250 strokes which occur subsequent to and in addition to S1's strokes), it can be seen that the thickness 42a of label 42 may be substantially reduced from that at step 40b by about 10% to about 75% or as shown in FIG. 4, substantially reduced to zero, exposing the exterior surface of the 43′ adhesive layer 43 whose thickness 43a will desirably remain the same as the initial thickness.

At step 40d, which occurs after S3, (e.g., about 200 strokes to about 250 strokes which occur subsequent to and in addition to S1 and S2's number of strokes), the thickness 43a of adhesive layer 43 may be reduced from that at step 40c by about 10% to about 75% or as shown, substantially reduced to zero.

Though only 3 consecutive shaves are depicted in the flow diagram of FIG. 4, the present invention contemplates any number of shaves (potentially up to about 10 shaves or up to about 2000 to about 2500 strokes) in which the erodible label and adhesive layer to both wear away completely. The composition of the erodible label and adhesive layer each plays a big role in the leach rate of the label. Generally, with more PEO present in the label or adhesive layer composition, the leach rate increases and thus the label and adhesive layer may thus each wear at a faster rate.

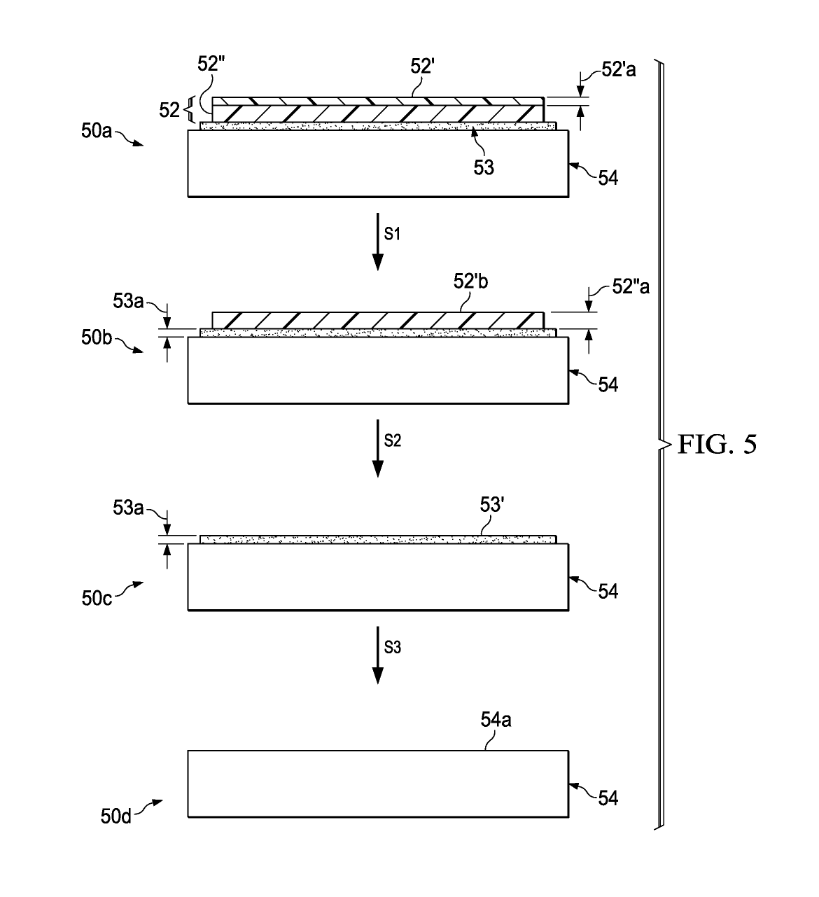

Referring now to FIG. 5, a label 52 which may desirably be formed via label transfer technology such as heat transfer processes and disposed onto a substrate 54 is shown in accordance with another aspect of the present invention having an adhesive layer 53 disposed therebetween.

Label 52 however may itself desirably be comprised of one or more labels layered on top of each other or covering one another (whether partially or fully) in which desirably are both labels erodible in accordance with the present invention.

For instance, as shown in FIG. 5, label 53 is comprised of two erodible labels or thought of as two label layers, an upper label layer 52′ and a lower label layer 52″ where the label layers 52′ and 52″ may have the same or different composition. For instance, erodible label layers 52′ and 52″ may be comprised of PEO in varying amounts. In addition, the leach rates may be different for each label layer depending on each label layer's composition oftentimes determined by the amount of PEO or any other water soluble polymer. Additionally, the erodible labels or label layers may be comprised of different designs, provide different cues or indicia, be of different colors, such that when the upper layer is worn away, the lower layer revealed is of a different color or design.

Though not shown, more than two erodible label layers are also contemplated in the present invention. Furthermore, the upper label layer 52′ may not cover the entirety of the lower label layer 52″ in the present invention (not shown).

The substrate 54 may be a lubrication ring or lubrastrip of PEO or PEO mixtures or may be a hard plastic such as a frame or clip or other component of a razor cartridge. Adhesive layer 53 may desirably act as an adhesive seal and is desirably comprised of water insoluble polymers (e.g., acrylic polymers) up to about 70% by weight of composition or other materials which will assist in adhesion and also, water soluble polymers such as those described for the erodible label of up to about 70% by weight of composition. The adhesive layer may additionally comprise a resin or glue.

The composition of the adhesive layer may also generally vary depending on the type of substrate it is being disposed on. For instance, if the substrate is such that substantial amounts of water soluble polymers are not sufficient to bond to the desired substrate, then the amounts of water insoluble polymers may generally increase in the adhesive layer composition. Thus, while the adhesive layer 53 may desirably have a substantial amount of water soluble polymers, much like the label itself, the adhesive layer of the present invention may desirably be of a different composition than that of the label 52 and while it is intended to also wear away, it may generally not wear as quickly as the label itself.

The formation of label 52 including layers 52′ and 52″ with adhesive layer 53 may desirably be formed at the same time in one label transfer process as described above with regard to FIG. 1.

In the flow diagram of FIG. 5, label 52 and adhesive layer 53 each have initial thicknesses 52a and 53a, respectively. Thickness 52 encompasses the thicknesses 52′a of upper label 52′ and lower label 52″.

As before with FIGS. 3 and 4, S1, S2, and S3 of FIG. 5 are intended to signify a 1^{st} Shave 1, a 2^{nd} Shave, and a 3^{rd} Shave, respectively, with each wet shave S1, S2, and S3 desirably ranging, on average, from about 200 to about 250 strokes (or more or less).

Starting at step 50a of FIG. 5, the thickness 52′a of the label 52 may initially be in the range of from about 0.001 mm to about 5.00 mm, and preferably be about 0.25 mm while the thickness 52″a of the lower label may range from about 0.001 mm to about 5.00 mm and preferably be about 0.50 mm and the thickness 53a of the adhesive layer 53 may range from about 0.001 mm to about 0.10 mm and preferably be about 0.025 mm to about 0.040 mm. Generally, the lower label 52″ and adhesive layer 53 may desirably not be as thick as the upper label 52′.

Referring now to FIG. 5's step 50b, which occurs after S1, (e.g., after about 200 strokes to about 250 strokes), it can be seen that the thickness 52′a of upper label 52′ may be reduced from that at step 50a as shown in FIG. 5, substantially to zero, exposing the exterior surface 52′b of the lower label 52″. Though not depicted, the upper label 52′ at this step 50b, may have been reduced by less than about 100% (e.g., anywhere from about 10% to about 75% of any dimension, e.g., thickness).

Thus far, the thicknesses 52″a and 53a desirably shall remain the same. Generally, because these layers are beneath the upper label, they will not wear until the upper label has worn away or eroded completely. Thus, at step 50b, the substrate 54 may desirably include an adhesive layer 53 and a label layer 52″ disposed on its exterior surface 54a.

Continuing on to step 50c, which occurs after S2, (e.g., after about 200 strokes to about 250 strokes which occur subsequent to and in addition to S1's strokes), it can be seen that the thickness 52″a of lower label layer 52″ may be substantially reduced from that at step 50b by about 10% to about 75% or as shown in FIG. 5, substantially reduced to zero thickness, exposing the exterior surface of the 53′ adhesive layer 53 whose thickness 53a will desirably remain the same as its initial thickness.

At step 50d, which occurs after S3, (e.g., after about 200 strokes to about 250 strokes which occur subsequent to and in addition to S1 and S2's number of strokes), the thickness 53a of adhesive layer 53 may be reduced from that at step 50c substantially reduced to zero as shown, or by about 10% to about 75%.

Though only 3 consecutive shaves are depicted in the flow diagram of FIG. 5, the present invention contemplates any number of shaves (potentially up to about 10 shaves or up to about 2000 to about 2500 strokes on average) in which the erodible labels and adhesive layer may wear away completely. The composition of each erodible label and adhesive layer each plays a big role in the leach rate of the label. Generally, the more PEO present in the label or adhesive layer composition, the more the leach rate increases and thus the label and adhesive layer may each wear at a faster rate.

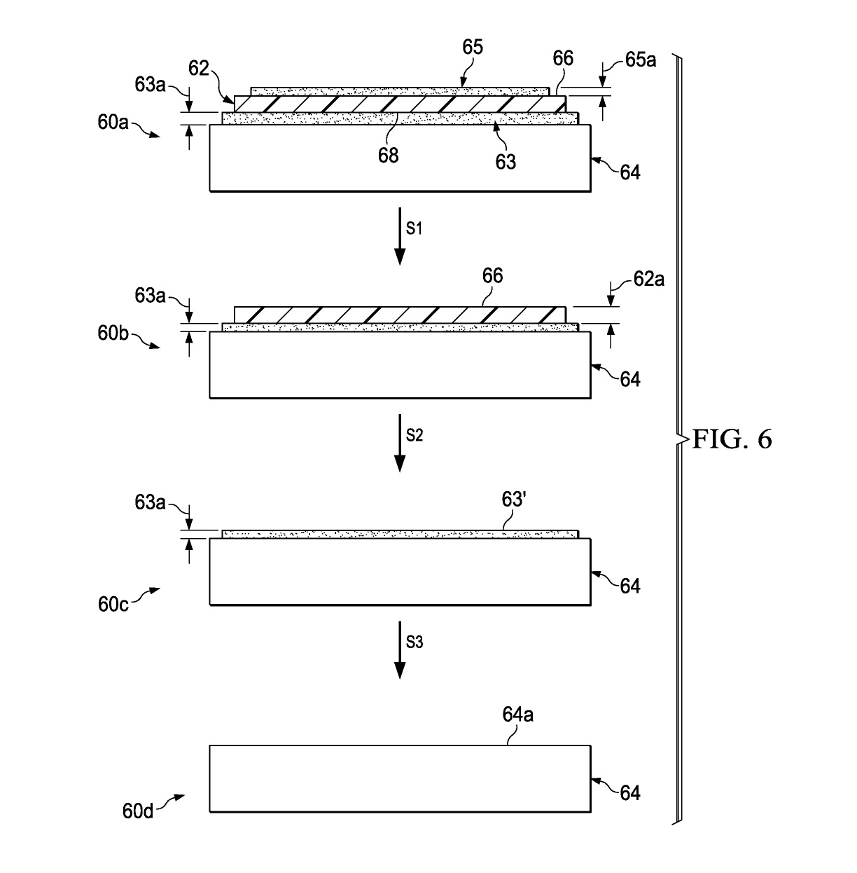

Referring now to FIG. 6, a label 62 which may desirably be formed via label transfer technology such as heat transfer processes and disposed onto a substrate 64 is shown in accordance with another aspect of the present invention sandwiched between two adhesive layers 63 and 65, one adhesive layer 65 disposed on a substantial portion of the label 62's upper surface 66 and one adhesive layer 63 on a substantial portion of label 62's lower surface 68 in accordance with an alternate embodiment of the present invention. It is contemplated that the erodible label and the adhesive layers may or may not cover each other's upper and lower surfaces entirely.

The adhesive layers generally comprise the same composition as the adhesive layers described above in FIGS. 4 and 5. As before, the erodible label and the adhesive layers may have the same or different compositions. In this embodiment, it may be desirably for adhesive layer 65 to wear at a faster rate than adhesive layer 63 and/or even the erodible label 62. Thus, the leach rates may be different for each, depending on each composition oftentimes determined by the amount of PEO or any other water soluble polymer. Additionally, it should be noted that the adhesive layers while they may provide a functional benefit in terms of adhesion and some lubricity, they generally may not provide designs or other indicia.

It may be desirable however that the erodible label and the adhesive layer be comprised of different colors, such that when the upper adhesive layer 65 is worn away and the erodible label 62 is revealed, a difference in color may be observed.

The substrate 64 may be any razor component described herein (e.g., a lube ring or lubrastrip of PEO or PEO mixtures or a hard plastic such as a frame or clip or blade).

The adhesive layers 63 and 65 may desirably act as adhesive seals and are preferably comprised of ingredients as mentioned above in conjunction with FIGS. 4 and 5.

The formation of label 62 with adhesive layers 63 and 65 may desirably be formed at the same time during one label transfer process as described above with regard to FIG. 1.

In the flow diagram of FIG. 6, label 62 and adhesive layers 63 and 65 each have initial thicknesses 62a, 63a, and 65a respectively.

Shaves S1, S2, and S3 of FIG. 6 are intended to signify a 1^{st} Shave 1, a 2^{nd} Shave, and a 3^{rd} Shave, respectively, with each wet shave S1, S2, and S3 desirably ranging from, on average, about 200 to about 250 strokes (or more or less).

Starting at step 60a of FIG. 6, the thickness 62a of the label 62 may initially be in the range of from about 0.001 mm to about 5.00 mm, and preferably at about 0.1 mm to about 0.30 mm while the thickness 63a of the adhesive layers 63 and 65 may range from about 0.001 mm to about 0.10 mm and preferably be about 0.025 mm to about 0.040 mm.

Referring now to FIG. 6's step 60b, which occurs after S1, (e.g., after about 200 strokes to about 250 strokes), it can be seen that the thickness 65a of upper adhesive layer 65 may be reduced from that at step 60a as shown in FIG. 6, substantially to zero (or anywhere from about 10% to about 75%, not shown), exposing the exterior or upper surface 66 of erodible label 62.

Thus, at step 60b, the substrate 64 may have disposed on its exterior surface 64a, an adhesive layer 63 and an erodible label 62.

At step 60c, which occurs after S2, (e.g., after about 200 strokes to about 250 strokes which occur subsequent to and in addition to S1's strokes), it can be seen that the thickness 62a of erodible label 62 may be substantially reduced from about 10% to about 75% or as shown in FIG. 6, substantially reduced to zero thickness, exposing the exterior surface of the 63′ adhesive layer 63 whose thickness 63a desirably has not thus far changed.

At step 60d, which occurs after S3, (e.g., after about 200 strokes to about 250 strokes which occur subsequent to and in addition to S1 and S2's number of strokes), the thickness 63a of adhesive layer 63 may be reduced from that at step 60c substantially reduced to zero as shown, or by about 10% to about 75%, exposing the exterior surface 64a of the substrate 64 which may be a lube ring.

The lube ring will continue to provide lubrication to the user but desirably will not wear as fast as the erodible label, nor the adhesive layer.

Though only 3 consecutive shaves are depicted in the flow diagram of FIG. 6, the present invention contemplates any number of shaves (potentially up to about 10 shaves or up to about 2000 to about 2500 strokes on average) in which the erodible label(s) and/or adhesive layer(s) may wear away completely.

Naturally, the composition of each erodible label and adhesive layer plays a big role in its respective leach rate. Generally, with more PEO or water soluble polymers present in the composition, the leach rate increases, and the wearing off occurs at a faster rate.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising at least one erodible label disposed on at least one exterior surface of at least one component of said razor cartridge.

2. The razor cartridge of claim 1 wherein said at least one erodible label is disposed onto said at least one exterior surface of said at least one component of said razor cartridge via at least one type of label transfer technology.

3. The razor cartridge of claim 1 wherein said at least one type of label transfer technology comprises a heat transfer process, a silk screen process, a roll coating process, a flexographic process, a rotogravure process, or any combination thereof.

4. The razor cartridge of claim 1 wherein said at least one erodible label comprises of from about 10% to about 100% by weight of composition of at least one water soluble polymer.

5. The razor cartridge of claim 1 wherein said at least one erodible label provides at least one functional benefit, at least one an aesthetic benefit, at least one cue, at least one indicia, or any combination thereof.

6. The cartridge of claim 5 wherein said at least one functional benefit comprises increased lubricant release, release of a scent during use, skin or hair improvements further comprising moisturization, hair minimization or acne-reduction, or any combination thereof.

7. The razor cartridge of claim 5 wherein said at least one aesthetic benefit comprises at least one pleasing sensation, at least one pleasing emotion obtained via a scent released during use, improved skin appearance, or a feeling that said razor cartridge is appealing, refreshing, clean, easy to use, moisturizing, relaxing, soothing, or safe for sensitive skin, or any combination thereof.

8. The razor cartridge of claim 5 wherein each of said at least one benefits, cue or indicia, is obtained by said user before, during or after use of said cartridge, or any combination thereof.

9. The razor cartridge of claim 1 wherein said at least one erodible label is comprised of polyethylene oxide (PEO), polyvinyl alcohol, polyvinyl pyrrolidone, polyurethane, polyacrylate, polyureas, polyalkylene glycols, cellulose based polymers, or any combination thereof.

10. The razor cartridge of claim 9 wherein said at least one erodible label is further comprised of scents, thermo-chromic pigments, lipids, waxes, moisturizing agents, exfoliating agents, inorganic salts, holographic inks, marbleized inks, hair growth retardants or inhibitors, or any combination thereof.

11. The razor cartridge of claim 1 wherein said erodible label wears away completely from said at least one exterior surface of said at least one razor cartridge component after about 2 to about 10 wet shaves.

12. The razor cartridge of claim 1 wherein a thickness of said erodible label is reduced by about 10% to about 75% after each shave.

13. The razor cartridge of claim 11 or 12 wherein each of said shaves is about 200 strokes to about 250 strokes.

14. The razor cartridge of claim 2 wherein said erodible label is not permanent after a curing step in said label transfer technology.

15. The razor cartridge of claim 1 wherein said erodible label comprises a plurality of erodible labels.

16. The razor cartridge of claim 15 wherein each of said plurality of erodible labels has a different label composition.

17. The razor cartridge of claim 1 wherein said at least one component comprises a portion of at least one of the following: a lubricating body, a cap, a housing, a frame, a clip, a guard, a razor blade, a cartridge connecting structure, or any combination thereof.

18. The razor cartridge of claim 17 wherein said lubricating body comprises at least one of the following: a lubricating ring, a lubricating strip, a soap, a gel bar, a foam embedded with a lubricious material, a shaving aid material disposed on said at least one razor cartridge component, or any combination thereof.

19. The razor cartridge of claim 1 wherein said at least one erodible label comprises one or more pattern, graphic, text, design, fragrance, or any combination thereof.

20. The razor cartridge of claim 1 wherein said at least one erodible label comprises one or more water droplets, flowers, floral patterns, sparkles, bubbles, words, images, scents, or any combination thereof.

21. The razor cartridge of claim 1 wherein said at least one erodible label is visible to a consumer at a point of purchase of a razor product.

22. The razor cartridge of claim 21 wherein said at least one erodible label's visibility allows said consumer to select said razor product according to their tastes.

23. The razor cartridge of claim 1 wherein a width of said at least one erodible label ranges from about 0.5 mm to about 45 mm, a length of said at least one erodible label ranges from about 0.5 mm to about 11 mm, and a height of said erodible label ranges from about 0.001 mm to about 5.00 mm above said exterior surface.

24. The razor cartridge of claim 1 wherein at least one adhesive layer is disposed onto said at least one exterior surface of said at least one razor cartridge component, onto an upper surface of said at least one erodible label, onto a lower surface of said at least one erodible label, or any combination thereof.

25. The razor cartridge of claim 24 wherein said at least one adhesive layer wears away during shaving.

26. The razor cartridge of claim 24 wherein said at least one adhesive layer is comprised of up to about 70% by weight of composition of at least one type of water insoluble polymer.

27. The razor cartridge of claim 24 wherein said at least one adhesive layer is comprised of a different composition than said at least one erodible label.

28. The razor cartridge of claim 24 wherein said at least one adhesive layer is disposed onto said at least one exterior surface of said at least one component of said razor cartridge via at least one type of label transfer technology.

29. The razor cartridge of claim 28 wherein said at least one type of label transfer technology comprises a heat transfer process, a silk screen process, a roll coating process, a flexographic process, a rotogravure process, or any combination thereof.

30. A razor cartridge comprising at least one erodible label disposed in a razor cartridge in place of a lubricating body, wherein said at least one erodible label is applied via a label transfer technology.

31. A method of making a razor cartridge comprising applying at least one erodible label onto at least one exterior surface of at least one component of said razor cartridge via at least one type of label transfer process wherein said at least one razor cartridge component comprises a portion of at least one of the following: a lubricating body, a guard, a cap, a housing, a frame, a clip, a razor blade, a cartridge connecting structure, or any combination thereof.

32. The method of claim 31 wherein the label transfer process comprises a heat transfer process, a silk screen process, a roll coating process, a flexographic process, a rotogravure process, or any combination thereof.

33. The method of claim 31 wherein said lubricating body is at least one of the following: a lubricating ring, a lubricating strip, a soap, a gel bar, a foam embedded with a lubricious material, a shaving aid material disposed on said at least one razor cartridge component, or any combination thereof.

34. The method of claim 31 wherein said at least one erodible label comprises from about 10% to about 100% by weight of composition of at least one water soluble polymer.

35. The method of claim 31 wherein said at least one erodible label provides at least one functional benefit, at least one an aesthetic benefit, at least one cue, at least one indicia, or any combination thereof, wherein said at least one functional benefit comprises increased lubricant release, release of a scent during use, skin or hair improvements further comprising moisturization, hair minimization or acne-reduction, or any combination thereof, wherein said at least one aesthetic benefit comprises at least one pleasing sensation, at least one pleasing emotion obtained via a scent released during use, improved skin appearance, or a feeling that said razor cartridge is appealing, refreshing, clean, easy to use, moisturizing, relaxing, soothing, or safe for sensitive skin, or any combination thereof, and wherein each of said at least one benefits, cue or indicia, is obtained by said user before, during or after use of said cartridge, or any combination thereof.

36. The method of claim 31 wherein said at least one erodible label is comprised of polyethylene oxide (PEO), polyvinyl alcohol, polyvinyl pyrrolidone, polyurethane, polyacrylate, polyureas, polyalkylene glycols, cellulose based polymers, or any combination thereof.

37. The method of claim 36 wherein said at least one erodible label is further comprised of scents, thermo-chromic pigments, lipids, waxes, moisturizing agents, exfoliating agents, inorganic salts, holographic inks, marbleized inks, hair growth retardants or inhibitors, or any combination thereof.

38. The method of claim 31 wherein said erodible label wears away completely from said at least one exterior surface of said at least one razor cartridge component after about 2 to about 10 wet shaves.

39. The method of claim 31 wherein a thickness of said erodible label is reduced by about 10% to about 75% after each shave.

40. The method of claim 38 or 39 wherein each of said shaves is about 200 strokes to about 250 strokes.

41. The method of claim 31 wherein said erodible label is not permanent after a curing step in said label transfer technology.

42. The method of claim 31 wherein said erodible label comprises a plurality of erodible labels.

43. The method of claim 31 wherein each of said plurality of erodible labels has a different label composition.

44. The method of claim 31 wherein said lubricating body comprises at least one of the following: a lubricating ring, a lubricating strip, a soap, a gel bar, a foam embedded with a lubricious material, a shaving aid material disposed on said at least one razor cartridge component, or any combination thereof.

45. The method of claim 31 wherein said at least one erodible label comprises one or more pattern, graphic, text, design, fragrance, or any combination thereof.

46. The method of claim 31 wherein said at least one erodible label is visible to a consumer at a point of purchase of a razor product.

47. The method of claim 31 wherein said at least one erodible label's visibility allows said consumer to select said razor product according to their tastes.

48. The method of claim 31 wherein a width of said at least one erodible label ranges from about 0.5 mm to about 45 mm, a length of said at least one erodible label ranges from about 0.5 mm to about 11 mm, and a height of said erodible label ranges from about 0.001 mm to about 5.00 mm above said exterior surface.

49. The method of claim 31 wherein at least one adhesive layer is disposed onto said at least one exterior surface of said at least one razor cartridge component, onto an upper surface of said at least one erodible label, onto a lower surface of said at least one erodible label, or any combination thereof.

50. The method of claim 31 wherein said at least one adhesive layer wears away during shaving.

51. The method of claim 31 wherein said at least one adhesive layer is comprised of up to about 70% by weight of composition of at least one type of water insoluble polymer.

52. The method of claim 31 wherein said at least one adhesive layer is disposed onto said at least one exterior surface of said at least one component of said razor cartridge via at least one type of label transfer technology.
